(19) United States
(12) Patent Application Publication
(10) Pub. No.: US 2021/0026844 A1
(43) Pub. Date: Jan. 28, 2021

(54) VIRTUAL BLOCKCHAIN SYSTEM, DATA MANAGEMENT METHOD, AND PROGRAM

(71) Applicant: NEC Corporation, Minato-ku, Tokyo (JP)

(72) Inventor: Toshio KOIDE, Tokyo (JP)

(73) Assignee: NEC Corporation, Minato-ku, Tokyo (JP)

(21) Appl. No.: 16/982,161

(22) PCT Filed: Mar. 28, 2018
(86) PCT No.: PCT/JP2018/012661

§ 371 Date: Sep. 18, 2020

(51) Int. Cl. G06F 16/23; G06F 16/27; H04L 9/08; G06F 21/64

(52) U.S. Cl. CPC G06F 16/2379; G06F 16/27; G06Q 20/0658; G06F 21/64; H04L 9/085

(57) ABSTRACT

A virtual blockchain system comprises: a blockchain management part that manages two or more pre-identified blockchain systems; a control part that determines a combination of data to be transmitted and blockchain, wherein the data to be transmitted includes data to be recorded and redundant data for restoring the data to be recorded, such that the data to be transmitted is distributedly shared by the two or more blockchain systems under a predefined redundancy rule; a data transmission part that transmits data destined to the blockchain systems according to the combination.

### TECHNICAL FIELD

The present invention relates to a virtual blockchain system, a data management method, and a program.

### BACKGROUND ART

Patent Literature 1 discloses a blockchain generation apparatus that is capable of generating blockchain data for a more secure and reliable digital virtual currency. This blockchain generation apparatus 1 includes synchronization part 121 for acquiring shared data 111 including block chain data 112 and transaction data 113 not included in the blockchain. Further, the blockchain generation apparatus 1 includes transaction pattern amount calculation means 124 for calculating a transaction pattern amount of a generator from transaction data related to an identifier of the generator using the blockchain generation apparatus 1. Further, the block chain generating apparatus 1 includes a block generation condition confirmation means 125 for determining whether the generator is qualified to generate new blockchain data based on the transaction pattern amount or not. Further, this blockchain generating device 1 includes blockchain generating means 126 that attempts to generate a new blockchain by referring to the shared data 111 when the block generating condition confirmation means 125 determines that the generator is qualified.

Many of the virtual currencies transacted on exchanges these days, such as Bitcoin (registered trademark) and Ethereum (registered trademark), are built on a public type blockchain. The public type blockchain is operated by multiple nodes, and as long as the operators of those nodes do not acquire majority authority, the blockchain is regarded to be neutral and capable of guaranteeing transparency and tamper resistance of data.

### CITATION LIST

### Patent Literature

[Patent Literature 1] Japanese Patent Kokai Publication No. JP2017-91149A

### SUMMARY OF INVENTION

### Technical Problem

The following analysis is given by the present invention. Even in the public type blockchains (may be termed as “public blockchain”, too, hereinafter) mentioned above, it may happen that the number of participating nodes is too small or that bugs exist in the code. Furthermore, as a human factor, there are problems of opposing opinions within a community and no sound operation, or even if it is currently operated sound, the soundness of the operation is not guaranteed in the future. In fact, as a result of these events, there are occurrences such that blockchains are split, operations are actually shut down, or their tamper resistance is lost, allowing to rewrite data. These events are unique to public blockchains, in part because they cannot be centrally controlled, unlike private type or consortium type blockchains.

On the other hand, the above mentioned blockchain is expected to be applied not only to virtual currencies but also to various services such as proofs of various types and history management. Applications (programs) to realize these services have also been proposed, but the instability of the above public blockchains is one of the bottlenecks for their spread.

It is an object of the present invention to provide a virtual blockchain system, a data management method, and a program that can contribute to improving the availability of services using the public type blockchain as described above.

### Solution to Problem

According to a first aspect of the invention, there is provided a virtual blockchain system, comprising: a blockchain management part that manages two or more pre-identified blockchain systems; a control part that determines a combination of data to be transmitted and blockchain, wherein the data to be transmitted includes data to be recorded and redundant data for restoring the data to be recorded, such that the data to be transmitted is distributedly shared by the two or more blockchain systems under a predefined redundancy rule; a data transmission part that transmits data destined to the blockchain systems according to the combination.

According to a second aspect of the invention, there is provided a data management method, wherein a computer comprises: a blockchain management part that manages two or more pre-identified blockchain systems, and a data transmission part that transmits data to be recorded destined to the blockchain systems; the computer comprising: a step of determining a combination of data to be transmitted and blockchain, wherein the data to be transmitted includes data to be recorded and redundant data for restoring the data to be recorded, such that the data to be transmitted is distributedly shared by two or more blockchain systems under a predefined redundancy rule; and a step of transmitting the data to the blockchain systems according to the combination.

According to a third aspect of the invention, there is provided a program for causing a computer comprising: a blockchain management part that manages two or more pre-identified blockchain systems and a data transmission part that transmits data to be recorded destined to the blockchain systems; to perform: a process that determines a combination of data that includes data to be recorded and redundant data for restoring the data to be recorded such that the data to be transmitted is distributedly shared by blockchain systems under a predefined redundancy rule; and a process that transmits data destined to the blockchain systems according to the combination.

### Meritorious Effect of the Invention

According to the present invention, it is possible to contribute to improving the availability of services using a public type blockchain.

### BRIEF DESCRIPTION OF THE DRAWINGS

FIG. 1 is a diagram showing a configuration of an exemplary embodiment of the present invention.

FIG. 2 is a diagram showing a description of an operation of an exemplary embodiment of the present invention.

FIG. 3 is a diagram showing a description of another operation of an exemplary embodiment of the present invention.

FIG. 4 is a diagram showing a configuration of a virtual blockchain system according to a first exemplary embodiment of the present invention.

FIG. 5 is a diagram showing an example of blockchain management information stored in a virtual blockchain system the first exemplary embodiment of the present invention.

FIG. 6 is a diagram showing an example of blockchain management information stored in a virtual blockchain system the first exemplary embodiment of the present invention.

FIG. 7 is a flow showing a function of a virtual blockchain system within a first exemplary embodiment of the present invention.

FIG. 8 is a diagram showing the operation of the virtual blockchain system according to the first exemplary embodiment of the present invention.

FIG. 9 is a diagram showing a configuration of a virtual blockchain system according to the second exemplary embodiment of the present invention.

FIG. 10 is a flow showing an operation of a virtual blockchain system according to the second exemplary embodiment of the present invention.

FIG. 11 is a diagram showing an operation of a virtual blockchain system according to the second exemplary embodiment of the present invention.

FIG. 12 is a diagram showing a configuration of a virtual blockchain system according to the third exemplary embodiment of the present invention.

FIG. 13 is a diagram showing an operation of the virtual blockchain system according to the third exemplary embodiment of the present invention.

FIG. 14 is a flow showing an operation of the virtual blockchain system according to the third exemplary embodiment of the present invention.

FIG. 15 is a diagram showing an operation of the virtual blockchain system according to the third exemplary embodiment of the present invention.

FIG. 16 is a diagram showing a configuration of a computer of a virtual blockchain system according to the present invention.

### DETAILED DESCRIPTION

First, an outline of one mode of this invention will be described with reference to the drawings. Reference numbers attached to the drawings in this outline are for convenience as an example for facilitating understanding, and not intended to limit the present invention to the illustrated modes. And each connection line between blocks in the reference drawing appearing in the following description includes both bi-directional and single-directional. A single-directional arrow describes main data flow schematically, which, however, does not exclude bi-directionality.

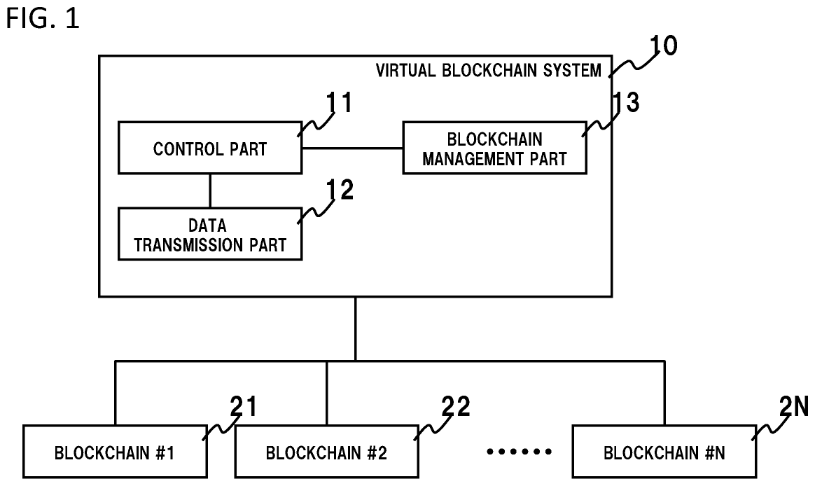

As shown in FIG. 1, in one exemplary embodiment, the present invention can be realized by a virtual blockchain system that comprises: control part 11, data transmission part 12, and blockchain management part 13.

In more detail, blockchain management part 13 manages two or more pre-identified physical blockchain systems 21-2N (from now, we also call the physical blockchain system as “blockchain”). Here, “manage” means that virtual blockchain system 10 manages so as to be able to transmit data to other blockchains, but does not manage other blockchains as a management host.

The data transmission part 12 transmits data to be recorded to the blockchain systems 21-2N. Here, data that the data transmission part 12 transmits depends on the usage etc. of this virtual blockchain system 10. For example, in a case where this virtual blockchain system 10 provides managing functions of virtual currency settlement or history in trading goods, etc., the data transmission part 12 transmits transaction data. Also instead of this transaction data, the data transmission part 12 may transmit distributed data (share) according to secret sharing, or parity data.

In the control part 11, a combination of data to be transmitted and the blockchain is determined, such that for the two or more blockchain system 21-2N, data to be recorded and redundant data for restoring the data to be recorded are respectively distributedly shared according to a predetermined redundancy rule.

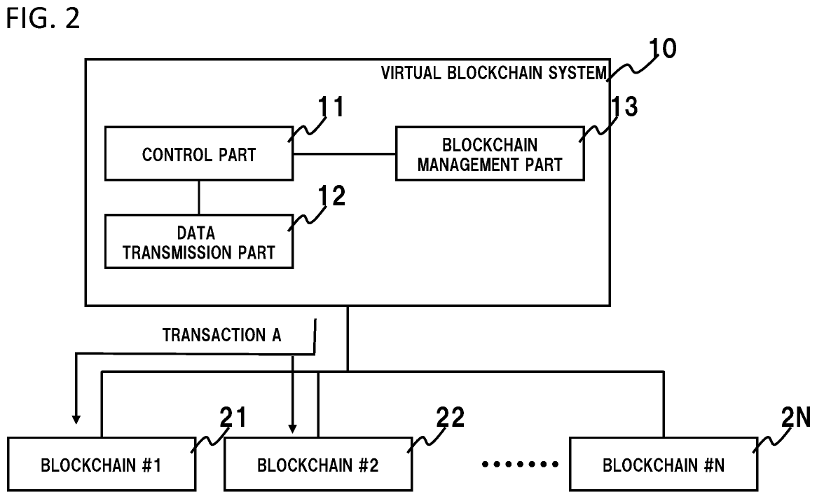

For example, assume that the control part 11 selects blockchain #1 (21) and blockchain #2 (22) from among two or more blockchains as shown in FIG. 2. And the control part 11 determines a combination of transmitting data to be recorded to one blockchain #1 (21) and transmitting the redundant data thereof to the other blockchain #2 (22). This realizes mirroring of ledger data. In each of the blockchains, the ledger is not only held in a tamper resistant state, but even if in one of the block chains stop of operating or branching may occur, the other blockchain can continue to operate. Instead of the above mentioned mirroring, a combination of real data and parity data may be transmitted as is the case with Level 3-5 of RAID (Redundant Arrays of Inexpensive Disks).

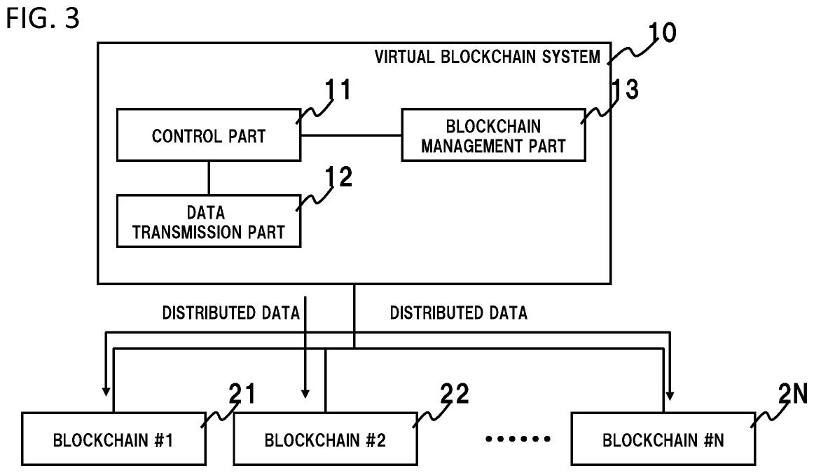

Further, as the data to be transmitted destined to the above mentioned blockchain, distributed data of the secret sharing scheme may be generated and transmitted to each of blockchains as shown in FIG. 3. By doing so, it becomes possible to construct a system that has both tamper resistance by the use of the blockchain, and resistance to leakage and hardware failure by the secret sharing scheme.

As described above, according to the present invention, it is possible to contribute to the spread of services using the public blockchains. The reason resides in that a stable virtual blockchain has been constructed by using the above-mentioned plurality of blockchains, and operational stability has been improved.

### FIRST EXEMPLARY EMBODIMENT

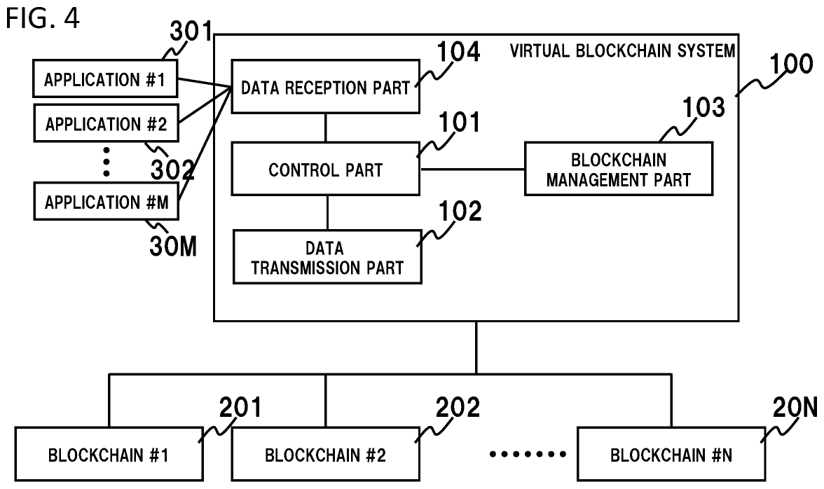

Subsequently, a first exemplary embodiment of the present invention will be described in detail with reference to the drawings. FIG. 4 shows a configuration of a virtual blockchain system according to the first exemplary embodiment of the present invention. FIG. 4 illustrates a configuration in which a virtual blockchains system 100 and two or more blockchains 201-20N are connected.

Two or more blockchains 201-20N are two or more physical blockchains similar to above mentioned blockchains 21-2N. Each of the blockchains 201 to 20N is configured to include a plurality of nodes (consensus forming nodes) that update their own ledger while forming a consensus. Further, the respective blockchains 201-20N do not have to have the same specification, and for example, the consensus forming algorithms of the respective blockchains 201-20N may be different. Further, in the present exemplary embodiment, the blockchains 201 to 20N are described as being public type blockchains, but some (a part) of them may be private type or consortium type blockchains.

The virtual blockchain system 100 sends (broadcasts) specified data respectively to the blockchains 201-20N thereby to add the specified data to the ledger of each of blockchains 201-20N via (after) consensus formation.

In particular, the virtual blockchain system 100 comprises control part 101, data transmission part 102, blockchain management part 103, and data reception part 104.

The data reception part 104 receives data from application programs 301 to 30M (hereinafter, simply referred to as “application”) that using the virtual blockchain system 100 of the present exemplary embodiment. The applications 301 to 30M are programs that operate on various terminal apparatuses connected to the network. The applications 301 to 30M may be different programs installed in a same terminal apparatus or may be the same program installed in different terminal apparatuses.

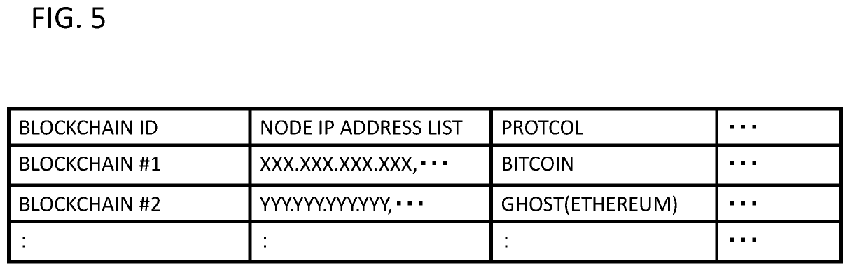

The blockchain management part 103 manages the blockchains 201-20N. FIG. 5. illustrates an example of blockchain management information the blockchain control part 103 holds. As an example in FIG. 5. there is shown a table storing entries representing allocation (correspondence) between a blockchain ID for determining a blockchain uniquely, IP address list of a belonging node (may be termed as “member node” hereinafter), and a protocol used in each blockchain. The IP address list of the member node includes IP addresses of any node in the blockchain. Instead of the IP address of any nodes in the blockchain, information of a DNS server that responds an IP address corresponding to a domain name given to the blockchain may be set. Although not shown in FIG. 5, other items such as block height may be held. The block height and other information may be obtained from a reliable node or the like.

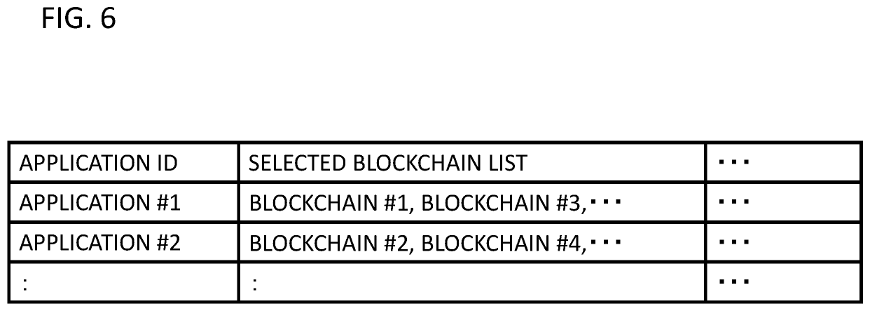

The blockchain management part 103 also manages a list of blockchains that are data transmission destinations (storage destinations) for each application. FIG. 6 is a diagram showing another example of the blockchain management information held by the blockchain management part 103. In the example of FIG. 6, a table storing entries in which an application ID for uniquely identifying an application and a blockchain list are associated with each other is shown. For example, when the virtual blockchain system 100 receives data of the application #1, with respect to the blockchains set in the blockchain list field, the virtual blockchain system 100 processes the data according to a protocol to be used with reference to the table of FIG. 5, respectively. Then, the virtual blockchain system 100 sends the processed data.

The blockchain selection rule set in the blockchain list of the table of FIG. 6 corresponds to the redundancy rule. As the redundancy rule, for example, a rule of selecting two or more blockchains having the same protocol can be considered. By adopting such a rule, the data processing can be made common. On the contrary, there may be a rule to select two or more blockchains having different protocols. By adopting such a rule, even if a failure caused by a protocol or a program occurs in one blockchain, it is possible to reduce the possibility that the other blockchain is affected. The redundancy rule is not limited to these examples, and for example, various rules for selecting a mix of blockchains based on the cost of registering data to each blockchain, soundness, and the like can be adopted.

When the control part 101 receives any data from the data reception part 104, the control part 101 identifies the application of its transmission source. Next, the control part 101 refers to the table shown in FIG. 6 to identify a blockchain that is the destination of the data of the identified application. Further, the control part 101 refers to the table of FIG. 5 and performs required processing on each of the specified blockchains, respectively. Further, the control part 101 refers to the table of FIG. 5 and instructs the data transmission part 102 to identify a blockchain of the transmission destination and to transmit the processed data. At this time, since there are two or more destination blockchains, either one of them functions as redundant data.

The data transmission part 102 transmits the identified data to the identified blockchain according to the instruction of the control part 101.

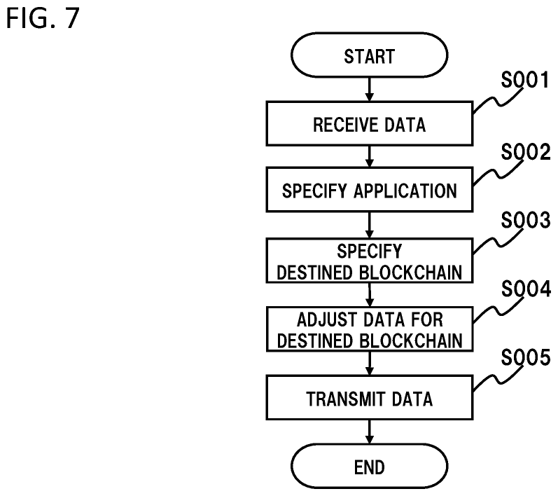

Next, the operation of this exemplary embodiment will be described in detail with reference to the drawings. FIG. 7 is a flow chart for explaining an operation of the virtual blockchain system according to the first exemplary embodiment of the present invention. Referring to FIG. 7, first, the virtual blockchain system 100 receives data from an arbitrary application (step S001).

Next, the virtual blockchain system 100 specifies the application of the transmission source of the received data (Step S002).

Next, the virtual blockchain system 100 specifies a blockchain or blockchains to be a destination(s) of the specified application with reference to table 6 shown in FIG. 6.

Next, the virtual blockchain system 100 refers to the table of FIG. 5 and performs required processing on each of the specified blockchains (step S004).

Next, the virtual blockchain system 100 transmits the processed data to the specified blockchain(s) respectively. (Step S005)

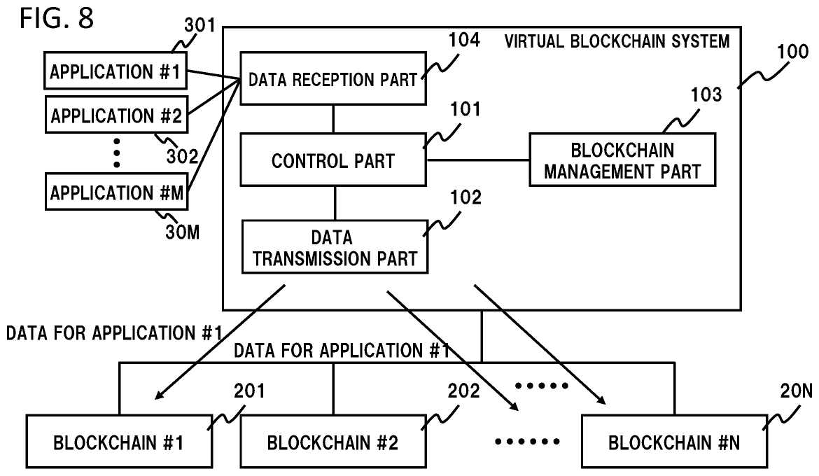

As described above, as shown in FIG. 8, the data received from the application is transmitted to the plurality of blockchains, consensus is formed in each blockchain, and then registered in a ledger data. As a result, for example, even when the data of the blockchain #1 in FIG. 8 is lost or the operation is stopped, the service to the application can be continued by using the data of the other blockchains to which the same data has been transmitted.

### SECOND EXEMPLARY EMBODIMENT

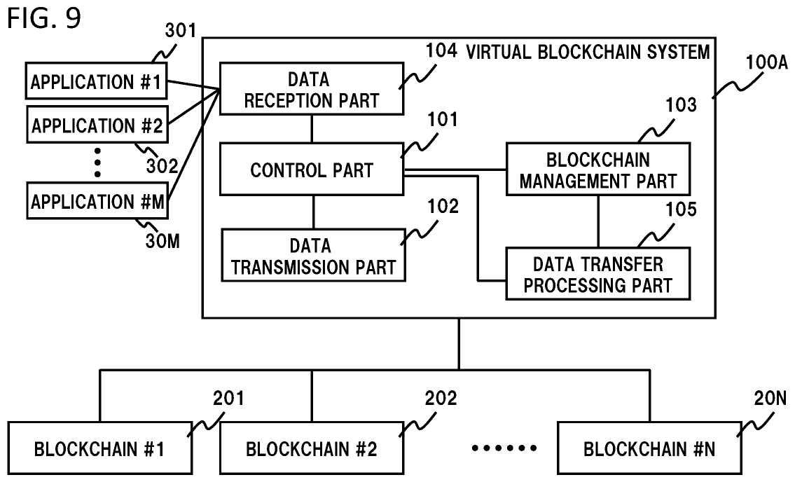

Next, a second exemplary embodiment of the present invention in which a transfer function of data accumulated in each blockchain is added will be described in detail with reference to the drawings. FIG. 9 is a figure which shows a configuration of a virtual blockchain system of the second exemplary embodiment of the present invention. Here, a data transfer processing part 105 is added to a virtual blockchain system 100, which is a different point from the first exemplary embodiment. Another structure or process is same as those of first mode. The other configurations and operations are the same as those of the first exemplary embodiment, and therefore the differences will be mainly described below.

The data transfer processing part 105 has a function of transferring ledger data of one blockchain or data extracted from the ledger data to another blockchain. As a start condition (trigger) for the data transfer processing part 105 to perform the data transfer processing, suspension of operation of the blockchain, occurrence of a division or the like is considered. Further, as another trigger to be considered are areas of increase in the redundancy for improving the stability of the virtual blockchain, and switching over to a more reliable blockchain.

Other than that, the operation of the data arrangement (distribution) by each part of the virtual blockchain system 100A is the same as that of the first exemplary embodiment, and the description thereof will be omitted.

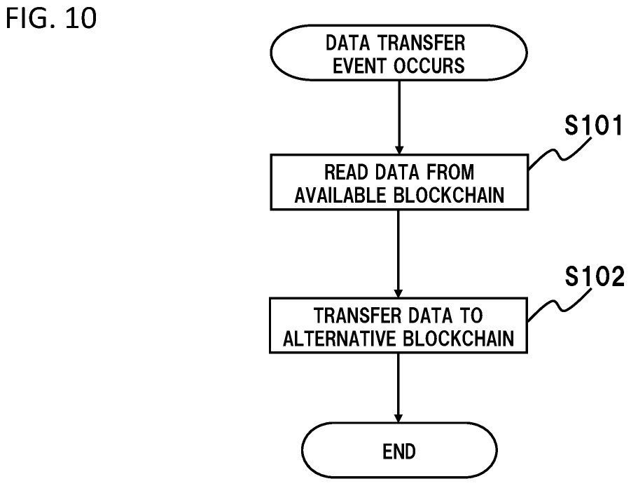

Next, the operation of this exemplary embodiment will be described in detail with reference to the drawings. FIG. 10 is a flow chart for explaining an operation of the virtual blockchain system of the second exemplary embodiment of the present invention.

Referring to FIG. 10, first, when a trigger such as an operation suspension or division of the blockchain is established, the virtual blockchain system 100A reads out data from the ledger of the blockchain holding the data to be transferred (i.e. transfer target data (step S101)). Here, as the data to be read, only the data transmitted from the virtual blockchain system 100A may be extracted.

Next, the virtual blockchain system 100A transfers the read data destined to the alternative blockchain selected by a predetermined rule (step S102).

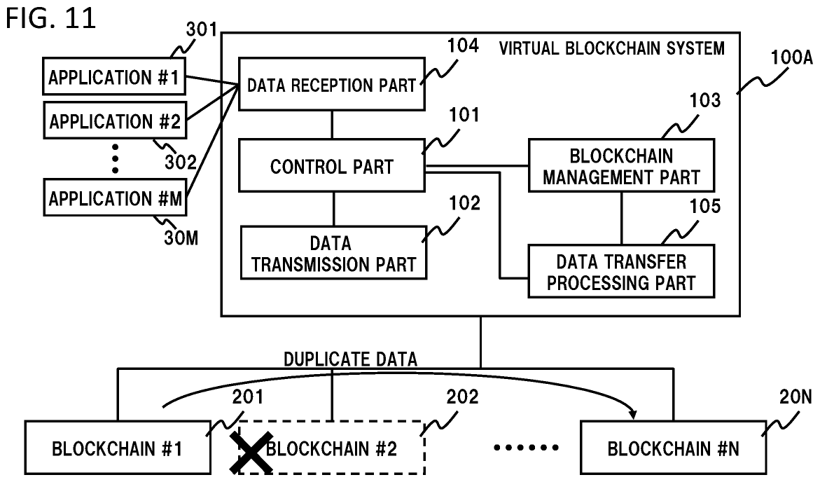

For example, the virtual blockchain system 100A reads the data of the blockchain #1 201 holding the same data when the operation of a certain blockchain (for example, a blockchain #2 202 in FIG. 11) is stopped. Then, the virtual block chain system 100A sends the read data to another blockchain (for example, a blockchain #N 20N in FIG. 11). As a result, it becomes possible to recover the redundancy lowered due to the stopping of operation of a blockchain (for example, a blockchain #2 202 in FIG. 11). Further, according to the present exemplary embodiment, since the ledger data is transferred, even if there is a change in the blockchain that is the transmission destination of the data of certain application, it is possible to trace the data backward prior to the change and ensure the redundancy of the data.

### THIRD EXEMPLARY EMBODIMENT

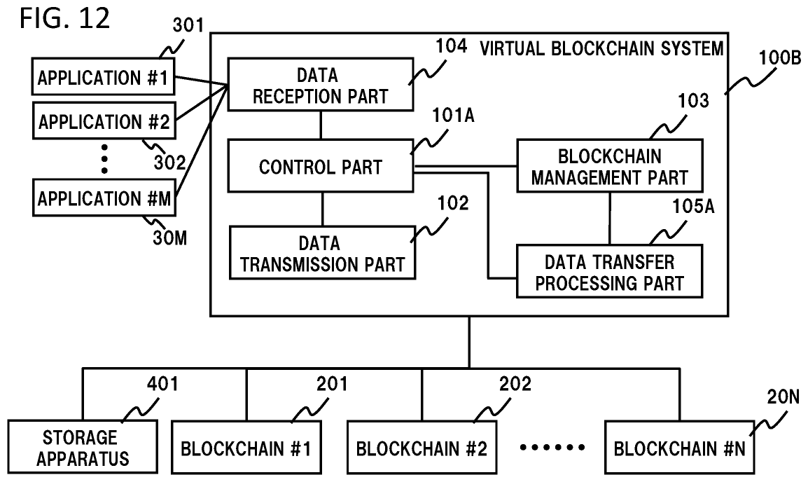

Next, a third exemplary embodiment will be described in which data to be sent to each blockchain is made confidential by using the secret sharing scheme and can be restored when necessary. FIG. 12: is a figure which shows a configuration of a virtual blockchain system of the third exemplary embodiment of this invention. The first difference in configuration from the virtual blockchain systems 100/100A of first and second exemplary embodiments resides in that the control part 101A and the function of the data transfer processing part 105A are changed. The second difference is that, in addition to the blockchains 201 to 20N, one or more storage apparatuses 401 can be a data allocation destination. The other configurations and operations are similar to those of the first and second exemplary embodiments, and hence the differences will be mainly described below.

Similarly to the first exemplary embodiment, a control part 101A specifies the application of transmission source of when data is received. Next, the control part 101A specifies a destination blockchain of a data of specified application with reference to a table shown in FIG. 6. Destination of the data of the application may include a storage apparatus(es). A sum of the blockchains and storage apparatuses is assumed to be equal to N. Hereinafter, these blockchains and storage apparatuses, which are the allocation destinations of distributed data, are collectively referred to as “blockchains et al”.

Further, the control part 101A creates N pieces of data using the data received from the data reception part 104. As a scheme of creating this data, for example, a scheme such as Shamir secret sharing scheme or the like, can be used, in which when a threshold value K is assumed, a (K−1)th order polynomial is used to create N distributed data (shares) using a predetermined secret.

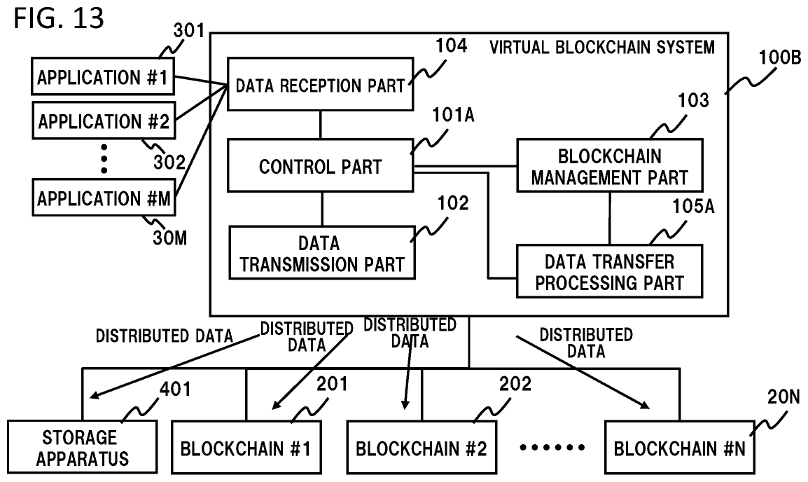

Further, the control part 101A instructs the data transmission part 102 to transmit the distributed data (share) by designating a blockchain(s) of the transmission destination. Upon receiving the instruction, the data transmission part 102 transmits the distributed data (share) to the designated blockchain(s) or storage apparatus(es) according to the instruction from the control part 101A (see FIG. 13). In this exemplary embodiment, a set of these data functions as data to be recorded and redundant data for restoring the data to be recorded.

The data transfer part 105A has a relocation function of the above-mentioned distributed data. Concretely, the data transfer part 105A reads out the data from the available K blockchains and restores the data received from the data reception part 104 when the destined location of the data is changed. Then, the data transfer part 105A cooperates with the control part 101A to create again the distributed data to be arranged in a new data arrangement destination, and transmits the data to the new data arrangement destination. The start condition (trigger) for the data transfer processing part 105A to perform the data transfer processing can be the same as in the second exemplary embodiment. However, in the present exemplary embodiment, data can be restored as long as K blockchains are available, so it is not always necessary to perform data transfer by (upon) stopping operation etc. of one blockchain. On the contrary, the data may be rearranged each time so that the number of available blockchains et al is kept to N.

Next, the operation of the present exemplary embodiment will be described in detail with reference to the drawings. As described above, the operation of arranging the data by the respective parts of the virtual blockchain system 100B is the same as that of the first exemplary embodiment except that the data processing (creation of distributed data) according to the destination of transmission is performed in step S004 of FIG. 7. The description is omitted because it is the same.

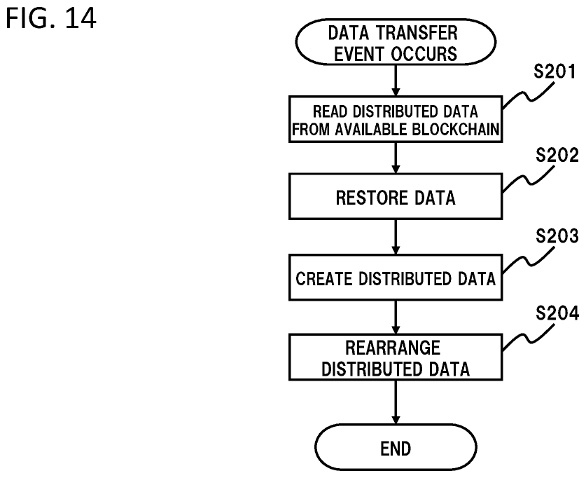

FIG. 14 is a flow chart for explaining the data transfer processing by the virtual block chain system according to the third exemplary embodiment of this invention. Referring to FIG. 14, first, when the above-mentioned trigger such as operation stop or division of the blockchain is established, the virtual blockchain system 100B reads the distributed data from a ledger of a blockchain holding a distributed data (step S201).

The virtual blockchain system 100B restores the data received from the data reception part 104 using the K or more data read out (Step S202).

Next, the virtual blockchain system 100B calculates the distributed data to be transmitted to blockchains et al of a new data arrangement (allocation) destination (Step S203).

Next, the virtual blockchain system 100B transmits the calculated distributed data to blockchains et al of the new data to allocation destination (Step S204).

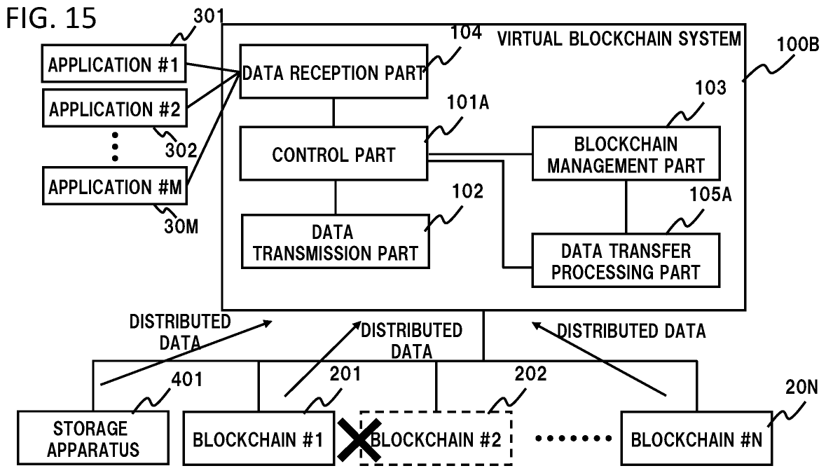

When, for instance, operation of any blockchain (for example, blockchain #2 202 in FIG. 15) halted, a virtual blockchain system 100B processes as follows. First, the virtual blockchain system 100B reads K distributed data from the storage apparatus 401, blockchains #1, 201, . . . , blockchain #N 20N that hold the distributed data. Then, the virtual blockchain system 100B restores the original data from the K pieces of read data. Then, the virtual blockchain system 100B creates distributed data again using the restored data and rearrange (relocate) the same on the blockchains.

As a result, it is possible to provide the blockchain service to the applications 301 to 30M while maintaining the security and confidentiality even if a failure occurs in the (N-K) blockchains et al among the N blockchains. Also in this exemplary embodiment, by restoring the distributed data retroactively and rearranging the distributed data, the redundancy of the data can be ensured by tracing back prior to the change, even if a specific blockchain is changed.

Although the respective exemplary embodiments of the present invention have been described above, the present invention is not limited to the above-described exemplary embodiments, and further modifications, replacements, and adjustments can be made without departing from the basic technical concept of the present invention. For example, the network configuration, the configuration of each element, and the expression form of the message shown in each drawing are examples for helping understanding of the present invention, and are not limited to the configurations shown in these drawings. Further, in the following description, “A and/or B” is used to mean at least one of A and B [that is, A or B, or (A+B)].

For example, the storage apparatus depicted as data destination above mentioned may be not only physical devices but may be virtual storage or storage network established on a virtual platform. And a virtual blockchain apparatus itself may be formulated using virtual machine (VM) on the virtual platform.

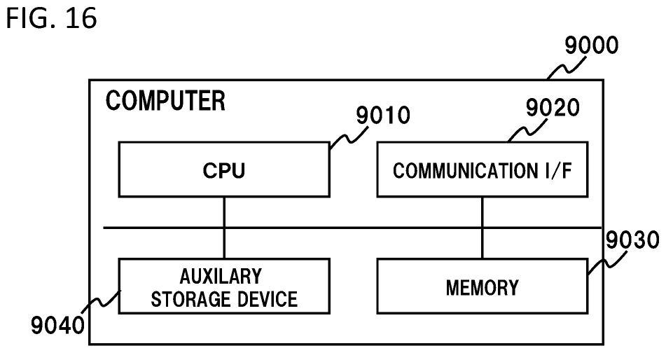

In addition, the procedure shown in the above-described first to third exemplary embodiments can be realized as a program for causing a computer (9000 in FIG. 16) that functions as the virtual blockchain system 100/100A/100B to execute processing as the virtual block chain system. For example, this kind of computer has a configuration comprising Central Processing Unit (CPU) 9010, Communication I/F 9020, Memory 9030, and Auxiliary Storage Device 9040 as described in FIG. 16. That is, the CPU 9010 of FIG. 16 executes the data transmission/reception program and the data conversion program, and refers to the block chain management information held in the auxiliary storage device 9040 to execute the processing of the received data and the data transmission processing.

That is, each part (processing means, function) of the virtual blockchain system shown in the above-described first to third exemplary embodiments can be realized by a computer program that causes the processor to perform the above-described processing by using the hardware of the processor mounted in the computer.

Finally, preferable modes of the present invention will be summarized.

### [Mode 1]

(Refer to above mentioned virtual blockchain system of the first aspect of the present invention.)

### [Mode 2]

The virtual blockchain system described above also comprises a data reception part that receives data transmitted from a predetermined terminal apparatus, the data being destined to a virtual blockchain system configured by using two or more blockchain systems.

### [Mode 3]

The control part of the virtual blockchain system described above may be configured in which the control part refers to information defining a relation between an application program of a transmission source of the data, and selects a blockchain allocated to the application program of the transmission, as a combination of the data and the blockchain.

### [Mode 4]

Above mentioned virtual blockchain system can also comprise data transfer part that transfers data held in a specified blockchain system among the two or more blockchain systems to an alternative blockchain system in place of the specified blockchain system.

### [Mode 5]

Above mentioned virtual blockchain system may comprise a predetermined storage apparatus with which data is diastiributedly shared, additional to the two or more blockchain systems.

### [Mode 6]

As the redundancy rule of above mentioned virtual blockchain system, predetermined secret sharing scheme is used.

### [Mode 7]

(Refer to data management method according to the second aspect of this invention.)

### [Mode 8]

(Refer to program according to the third aspect of the invention)

Mode 7 and Mode 8 can be expanded to Modes 2 to 6 likewise as the Mode 1.

It is to be noted that each of the disclosures in the abovementioned patent literatures is incorporated herein by reference. Modifications and adjustments of embodiments and examples are possible within the bounds of the entire disclosure (including the claims) of the present invention, and also based on fundamental technological concepts thereof. Furthermore, a wide variety of combinations and selections of various disclosed elements is possible within the scope of the claims of the present invention. That is, the present invention clearly includes every type of transformation and modification that a person skilled in the art can realize according to the entire disclosure including the claims and to technological concepts thereof. In particular, with respect to the numerical ranges described in the present application, any numerical values or small ranges included in the ranges should be interpreted as being specifically described even if not otherwise explicitly recited.

### SIGNS LIST

10, 100, 100A, 100B Virtual Blockchain System
11 Control Part
12 Data Transmission Part
13 Blockchain Management Part
21-2N, 201-20N Physical Blockchain System (Blockchain)
101, 101A Control Part
102 Data Transmission Part
103 Blockchain Management Part
104 Data Reception Part
105, 105A Data Transfer Processing Part
301-30N Application (Program)
401 Storage Apparatus
9000 Computer
9010 CPU
9020 Communication I/F
9030 Memory
9040 Auxiliary Storage Device

What is claimed is:

1. A virtual blockchain system, comprising:
a blockchain management part that manages two or more pre-identified blockchain systems;
a control part that determines a combination of data to be transmitted and blockchain, wherein the data to be transmitted includes data to be recorded and redundant data for restoring the data to be recorded, such that the data to be transmitted is distributedly shared by the two or more blockchain systems under a predefined redundancy rule;
a data transmission part that transmits data destined to the blockchain systems according to the combination.

2. The virtual blockchain system according to claim 1, further comprising a data reception part that receives data transmitted from a predetermined terminal apparatus, the data being destined to a virtual blockchain system configured by using the two or more blockchain systems.

3. The virtual blockchain system according to claim 1, wherein the control part refers to information defining a relation between an application program of a transmission source of the data and a blockchain being a storage destination of the data transmitted from the application program; and
selects a blockchain allocated to the application program of the transmission source of the data.

4. The virtual blockchain system according to claim 1, further comprising a data transfer part that transfers data held in a specified blockchain system among the two or more blockchain systems to an alternative blockchain system in place of the specified blockchain system.

5. The virtual blockchain system according to claim 1, wherein, additional to the two or more blockchain systems, the system comprises a predetermined storage apparatus with which data is distributedly shared.

6. The virtual blockchain system according to claim 1, wherein a predetermined secret sharing scheme is used as the predefined redundancy rule.

7. A data management method, wherein a computer comprises:
a blockchain management part that manages two or more pre-identified blockchain systems, and
a data transmission part that transmits data to be recorded destined to the blockchain systems;
the computer performing processings comprising:
determining a combination of data to be transmitted and blockchain, wherein the data to be transmitted includes data to be recorded and redundant data for restoring the data to be recorded, such that the data to be transmitted is distributedly shared by two or more blockchain systems under a predefined redundancy rule; and
transmitting the data to the blockchain systems according to the combination.

8. The data management method according to claim 7, further comprising;
receiving the data transmitted from a predetermined terminal apparatus, destined to the virtual blockchain system configured by using the two or more blockchain systems.

9. The data management method according to claim 7, comprising;
referring to information defining a relation between an application program of a transmission source of the data and a blockchain being a storage destination of the data transmitted from the application program; and
selecting a blockchain allocated to the application program of the transmission source of the data as a result of the information defining a relation.

10. A non-transient computer readable medium storing a program for causing a computer comprising:
a blockchain management part that manages two or more pre-identified blockchain systems and
a data transmission part that transmits data to be recorded destined to the blockchain systems;
to perform:
a process that determines a combination of data that includes data to be recorded and redundant data for restoring the data to be recorded such that the data to be transmitted is distributedly shared by blockchain systems under a predefined redundancy rule; and
a process that transmits data destined to the blockchain systems according to the combination.

11. The virtual blockchain system according to claim 2, wherein the control part refers to information defining a relation between an application program of a transmission source of the data and a blockchain being a storage destination of the data transmitted from the application program; and
selects a blockchain allocated to the application program of the transmission source of the data.

12. The virtual blockchain system according to claim 2, further comprising a data transfer part that transfers data held in a specified blockchain system among the two or more blockchain systems to an alternative blockchain system in place of the specified blockchain system.

13. The virtual blockchain system according to claim 2, wherein, additional to the two or more blockchain systems, the system comprises a predetermined storage apparatus with which data is distributedly shared.

14. The virtual blockchain system according to claim 2, wherein a predetermined secret sharing scheme is used as the predefined redundancy rule.

15. The data management method according to claim 8, comprising;
referring to information defining a relation between an application program of a transmission source of the data and a blockchain being a storage destination of the data transmitted from the application program; and
selecting a blockchain allocated to the application program of the transmission source of the data as a result of the information defining a relation.

16. The data management method according to claim 7, further comprising transferring data held in a specified blockchain system among the two or more blockchain systems to an alternative blockchain system in place of the specified blockchain system.

17. The data management method according to claim 8, further comprising transferring data held in a specified blockchain system among the two or more blockchain systems to an alternative blockchain system in place of the specified blockchain system.

18. The data management method according to claim 9, further comprising transferring data held in a specified blockchain system among the two or more blockchain systems to an alternative blockchain system in place of the specified blockchain system.

19. The data management method according to claim 7, wherein data is distributedly shared by a predetermined storage apparatus additional to the two or more blockchain systems.

20. The data management method according to claim 7, wherein a predetermined secret sharing scheme is used as the predefined redundancy rule.
